(19) United States
(12) Patent Application Publication
(10) Pub. No.: US 2023/0077455 A1
(43) Pub. Date: Mar. 16, 2023

(54) MATRIX CALCULATION METHOD AND DEVICE

(71) Applicant: Jae Mo SUNG, Hwaseong-si (KR)

(72) Inventor: Jae Mo SUNG, Hwaseong-si (KR)

(21) Appl. No.: 17/931,741

(22) Filed: Sep. 13, 2022

Related U.S. Application Data
(63) Continuation of application No. PCT/KR2021/002448, filed on Feb. 26, 2021.

(30) Foreign Application Priority Data
Mar. 13, 2020 (KR) 10-2020-0031387

(51) Int. Cl. G06F 17/16

(52) U.S. Cl. CPC G06F 17/16

(57) ABSTRACT

Provided are a matrix calculation method and device. According to some embodiments of the present invention, a matrix calculation framework intervenes in the compilation or execution of program code including a matrix expression, thereby optimizing matrix calculation. Accordingly, the program code creator's burden of optimizing the matrix calculation can be reduced.

### CROSS REFERENCE TO RELATED APPLICATIONS AND CLAIM OF PRIORITY

[1] The present application is a continuation of International Patent Application No. PCT/KR2021/002448, filed on Feb. 26, 2021, which is based upon and claims the benefit of priority to Korean Patent Application No. 10-2020-0031387, filed on Mar. 13, 2020. The disclosures of the above-listed applications are hereby incorporated by reference herein in their entirety

### TECHNICAL FIELD

The present invention relates to a matrix calculation method and device, and more particularly, to a matrix calculation method and device capable of performing a matrix operation on a matrix calculation framework so as for the creator of a program code including the matrix calculation does not need to be concerned about the optimization of the matrix calculation.

### BACKGROUND ART

Matrix calculation is included in various fields of computing. For example, matrix calculation is performed in various fields that are being actively researched in recent years, such as the fields of machine learning, including deep learning, computer vision, signal processing, big data analysis, bioinformatics, or intelligent robotics.

However, matrix calculation by some existing programming languages or mathematical calculational libraries has the problem of using computing resources inefficiently. Referring to FIG. 1, in order to calculate the result of a matrix expression 10, the result of (A+B) is assigned to a temporary storage space T1, the result of exp(T1) is assigned to a temporary storage space T2, the result of transpose (C) is assigned to a temporary storage space T3, and the result of T2+T3 is assigned to a temporary storage space T4. This type of existing matrix operation has problems such as insufficient memory space due to an excessive use of temporary storage space, and an unnecessary use of calculational resources for allocating and releasing temporary storage space. Particularly, the problem of insufficient memory space may become more apparent when the data size of a matrix is large.

Also, matrix calculation by some existing mathematical calculational libraries provides optimization in units of matrix operations, but not in units of matrix expressions. For example, even Basic Linear Algebra Subprogram (BLAS), which is a set of low-level routines that provide various operations related to linear algebra, simply provides an optimized routine for a matrix product, but is not able to optimize the calculation of an entire matrix expression consisting of various operations.

Therefore, the provision of a technique is needed for improving the performance of a program by optimizing the calculation of a matrix expression without bothering a software developer who writes program code including the matrix expression as to the optimization of the calculation of the entire matrix expression.

### DISCLOSURE

### Technical Problems

To address the aforementioned problems, exemplary embodiments of the present invention provide a matrix calculation method and device capable of optimizing the calculation of an entire matrix expression.

Exemplary embodiments of the present invention also provide a matrix calculation method and device using a framework that supports the function of optimizing the calculation of a matrix expression without modifying program code.

Additional advantages, subjects, and features of the invention will be set forth in part in the description which follows and in part will become apparent to those having ordinary skill in the art upon examination of the following or may be learned from practice of the invention.

### Technical Solutions

According to an aspect of the present invention, a matrix calculation method may include a matrix expression conversion step of generating a transformation matrix expression by transforming an original matrix expression included in program code, the operation included in the transformation matrix expression is classified into one of an operation of a first type and an operation of a second type a matrix evaluation step of creating a calculation formula for each element value of a final result matrix by evaluating the transformation matrix expression, calculating a calculation result matrix of the operation of the second type, which is referenced as an operand matrix of the calculation formula, and storing the calculation result matrix of the operation of the second type in temporary storage space and a matrix calculation step of calculating element values of the final result matrix by using a result of calculation of the operation of the first type in accordance with the calculation formula, with the use of element values of the calculation result matrix of the operation of the second type, stored in the temporary storage space.

In an embodiment, the operation of the first type may be a matrix operation that can be computed even when element values of an operand matrix are only accessible, and the operation of the second type may be a matrix operation that can be calculated when all element values of an operand matrix are accessible. Here, the converting the original matrix expression into the transformation matrix expression, may comprise classifying each operation included in the original matrix expression into the first type or the second type by referencing operation-wise type matching data, or may comprise classifying each operation included in the original matrix expression, basically, into the first type and classifying each operation included in the original matrix expression into the second type, only if an exception rule is satisfied. Also, the converting the original matrix expression into the transformation matrix expression, may comprise classifying each operation included in the original matrix expression into one of the first and second types by reflecting hardware specification information of the computing device. For instance, the classifying each operation included in the original matrix expression into one of the first and second types by reflecting the hardware specification information of the computing device, may comprise classifying a first operation included in the original matrix expression into the first type if a memory size of the computing device is less than a first size, and classifying the first operation into the second type if the memory size of the computing device is greater than, or the same as the first size. The converting the original matrix expression into the transformation matrix expression may be performed at a time of execution of the program code. And the converting the original matrix expression into the transformation matrix expression, may comprise classifying each operation included in the original matrix expression into one of the first and second types in consideration of available hardware resources at a time of matrix expression conversion by the computing device.

In an embodiment, the converting the original matrix expression into the transformation matrix expression, may comprise classifying a first operation into the second type if a result of calculation of the first operation is an operand of other multiple operations. Here, the multiple operations may include operations of a neighboring matrix expression of the original matrix expression, Here, the neighboring matrix expression may be a matrix expression not including a statement for changing element values of a primary matrix between the original matrix expression and the neighboring matrix expression, on the program code, and the element values of the primary matrix may be stored in a memory of the computing device.

In an embodiment, the converting the original matrix expression into the transformation matrix expression, may comprise performing the evaluating the transformation matrix expression and the calculating the calculation result matrix, while changing a result of classification of the type of each operation included in the transformation matrix expression, and measuring execution time, and determining an optimal type of each operation included in the transformation matrix expression based on the execution time.

In an embodiment, The evaluating the transformation matrix expression, may comprise identifying a calculation flag of the calculation result matrix of the operation of the second type, and calculating a result of calculation of the operation of the second type and storing data of the calculation result matrix of the operation of the second type in temporary storage space, if the calculation flag indicates that the calculation of the operation of the second type is yet to be performed.

In an embodiment, the converting the original matrix expression, the evaluating the transformation matrix expression, the calculating the calculation result matrix, may be performed when the element values of the final result matrix of the original matrix expression are accessed by an application program formed by the program code. Also, the converting the original matrix expression, the evaluating the transformation matrix expression, the calculating the calculation result matrix, may be performed by a matrix calculation framework module included in a program of the program code. Moreover, the converting the original matrix expression, the evaluating the transformation matrix expression, the calculating the calculation result matrix, may be performed when an operator that is overloaded by a matrix calculation framework module included in the program of the program code and assigns the original matrix expression to another matrix is executed or when an evaluation for the original matrix expression, overloaded by the matrix calculation framework module, is called.

In an embodiment, the matrix calculation step may include calculating the element values of the final result matrix by calculating, element-wise, the calculation formula, which references each of the element values of the calculation result matrix of the operation of the second type, stored in the temporary storage space.

In an embodiment, the converting the original matrix expression into the transformation matrix expression, may comprise converting the original matrix expression into the transformation matrix expression, which is a set of meta matrices that are combinations of operations of the first type or the second type and operand matrices of the operations. Here, each of the operand matrices may be at least one of a primary matrix whose element values are stored in a memory of the computing device and a meta matrix whose element values are not stored in the memory of the computing device.

According to an aspect of the present invention, A matrix calculation method may comprise including a matrix calculation framework module in a program of program code including an original matrix expression and performing, by the matrix calculation framework module, an optimized matrix calculation if element values of a result matrix of the original matrix expression are accessed. Here, the performing the optimized matrix calculation, may comprise classifying an operation of the original matrix into one of an operation of a first type, which is a matrix operation that can be computed even when element values of an operand matrix are only accessible, and an operation of a second type, which is a matrix operation that can be calculated when all the element values of the operand matrix are accessible, calculating a result matrix of the operation of the second type and storing data of the result matrix of the operation of the second type in temporary storage space of the computing device, and calculating each element value of the result matrix of the original matrix expression by using a calculation formula for each element value of the result matrix of the original matrix expression. Here, the calculation formula includes the operation of the first type and an operand matrix of the operation of the first type, and the operand matrix may be at least one of a result matrix of the operation of the second type and a primary matrix whose element values are stored in a memory of the computing device.

In an embodiment, the performing the optimized matrix calculation, may comprise performing, by the matrix calculation framework module, the optimized matrix calculation when the element values of the result matrix of the original matrix expression included in the program code are accessed during compilation of the program code.

the performing the optimized matrix calculation, may comprise performing, by the matrix calculation framework module, the optimized matrix calculation when the element values of the result matrix of the original matrix expression included in the program code are accessed during execution of the program code.

the classifying the operation of the original matrix into one of the first and second types, may comprise generating, by the matrix calculation framework module, a hardware profile by using at least one of hardware specification information and available hardware resource information of the computing device, and classifying, by the matrix calculation framework module, the operation of the original matrix into one of the first and second types by using the hardware profile.

A matrix calculation method may comprise including a matrix calculation framework module in a program of program code including a matrix expression and performing, by the matrix calculation framework module, matrix calculation at a time of compilation or execution of the program code. Here, the performing the matrix calculation, comprises classifying an operation of the matrix expression into one of first and second types, and calculating each element value of a result matrix of the matrix expression with an operation of the first type, and data of a result matrix of an operation of the second type, among operand matrices of the operation of the first type, is accessed from temporary storage space of the computing device.

According to another aspect of the present invention, a matrix calculation method may include acquiring a matrix expression, which includes first, second and third operations, by parsing program code; determining the first and second operations as operations of a first type, which can be computed when element values of an operand matrix are only accessible, and determining the third operation as an operation of a second type, which can be computed when all element values of an operand matrix are accessible; calculating the third operation, which is an operation of the second type, and storing a result matrix of the third operation in temporary storage space, which is provided in a computing device; and calculating a result matrix of the matrix expression, which includes a batch computation of the first and second operations, the operations of the first type, wherein at least one of the first and second operations has a result of the calculation of the third operation, stored in the temporary storage space, as an operand. The determining may include determining the first, second, and third operations as operations of one of the first and second types by using at least one of execution environment information and specification information of the computing device. Here, a program of the program code may include a matrix calculation framework module, and the determining, the storing, and the calculating may be performed by the matrix calculation framework module. The determining may include performing optimization to transform the matrix expression as long as the result matrix of the matrix expression is the same, and the storing and the calculating may be performed on the transformed matrix expression.

### BRIEF DESCRIPTION OF DRAWINGS

FIG. 1 is a diagram for explaining a prior-art matrix calculation process;

FIG. 2 is a diagram for explaining an element-wise matrix calculation method according to some embodiments of the present invention;

FIGS. 3 and 4 are hierarchical structural diagrams of matrix calculation devices according to some embodiments of the present invention;

FIG. 5 is a diagram for explaining a program code writing method for using a matrix calculation framework module, according to some embodiments of the present invention;

FIG. 6 is a block diagram of a matrix calculation device according to an embodiment of the present invention;

FIGS. 7 to 14 are diagrams for explaining an operation of the matrix calculation device of FIG. 6;

FIGS. 15 and 16 are block diagrams of matrix calculation devices that differ in terms of the hierarchical arrangement of a matrix calculation framework module;

FIG. 17 is a hardware configuration diagram for explaining the hardware structure of an exemplary first computing device for implementing a method according to some embodiments of the present invention;

FIGS. 18 and 19 are diagrams for explaining a memory loading area of a matrix calculation framework module according to some embodiments of the present invention.

FIG. 20 is a hardware configuration diagram for explaining a hardware structure of an exemplary second computing device for implementing a method according to some embodiments of the present invention.

FIG. 21 is a flowchart of a matrix calculation method according to another embodiment of the present invention.

FIGS. 22 through 24 are diagrams for explaining some operations as performed in the matrix calculation method of FIG. 21.

FIG. 25 is a diagram for explaining how to insert some routines in program code including a matrix expression at compile time or run time, according to some embodiments of the present invention.

FIGS. 26 through 30 are diagrams for explaining the inserted routines of FIG. 25.

FIG. 31 is a diagram for explaining how to apply the matrix calculation method to an exemplary matrix expression.

FIG. 32 is a control flow graph showing the order in which the inserted routines of FIG. 25 are called for an exemplary matrix expression.

FIG. 33 is a diagram for explaining how processes described with reference to FIG. 31 change in a case where the types of some operations of the exemplary matrix expression of FIG. 32.

FIG. 34 is a control flow graph showing the order in which the inserted routines of FIG. 25 are called for an exemplary matrix expression of FIG. 33.

FIG. 35 is a diagram for explaining how to insert some routines in program code including a plurality of matrix expressions at compile time or run time, according to some embodiments of the present invention.

### BEST MODES FOR CARRYING OUT THE INVENTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this invention will be thorough and complete and will fully convey the concept of the invention to those skilled in the art, and the present invention will only be defined by the appended claims.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

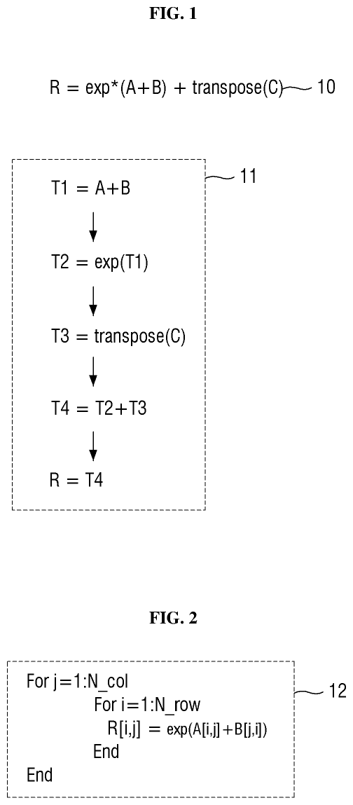

According to some embodiments of the present invention, a batch computation 12 of matrix operations is performed element-wise, unlike in the prior-art method described with reference to FIG. 1. That is, it may be understood that unlike in the prior art of FIG. 1, the calculation timing of each of the matrix operations is delayed to the timing of the batch computation 12 of the matrix operations. As the batch calculation 12 of the matrix operations is performed element-wise, the use of temporary storage space can be suppressed as much as possible.

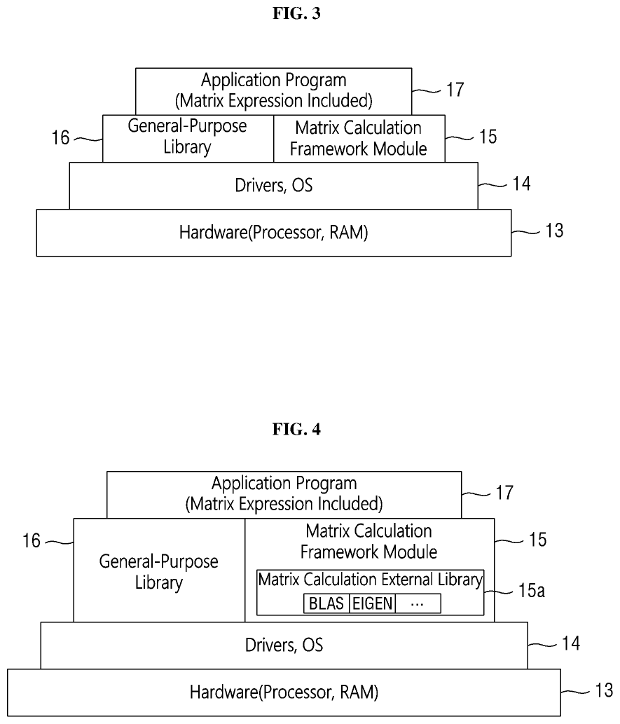

FIGS. 3 and 4 are hierarchical structural diagrams of matrix calculation devices according to some embodiments of the present invention. Referring to FIGS. 3 and 4, an application program 17, which is implemented by a program code including a matrix expression, either links a general-purpose library 16 and a matrix calculation framework module 15 or includes the general-purpose library 16 and the matrix calculation framework module 15 as parts of the program code, controls a driver/operating system (OS)14 by using the general-purpose library 16 and the matrix calculation framework module 15, and eventually utilizes the calculational resources of hardware 13.

In some embodiments, the application program 17 may include at least some routines of the matrix calculation framework module 15 at compile time. That is, the matrix calculation framework module 15 may be implemented in a template metaprogramming method. Here, a compiler may include only a routine needed for the application program 17, among all the routines of the matrix calculation framework module 15, in a binary of the application program 17. The routine needed for the application program 17 may include all operations for computing the result of a matrix expression included in program code of the application program 17. For example, if the matrix expression included in the program code of the application program 17 consists of sums (+) and products (*) of a matrix and both the sums (+) and the products (*) of the matrix are implemented as Element accessible OPerations (EOPs), which will be described later, the routine needed for the application program 17 may be matrix sums (+) and matrix products (*) of EOPs.

Each of the routines of the matrix calculation framework module 15 may be implemented as a template such that a compiler of the application program 17 may be able to determine which of the routines of the matrix calculation framework module 15 are to be included in the binary of the application program 17, at compile time, and each template may include execution code of a routine and may be written in a header file. Accordingly, the developer of the application program 17 can apply a matrix calculation method according to some embodiments of the present invention simply by writing a source code including the header file.

As illustrated in FIG. 4, the matrix calculation framework module 15 includes a matrix calculation external library 15a which provides routines of matrix calculation. Thus, in a case where a particular operation is included in a matrix expression, not only routines implemented by the matrix calculation framework module 15, but also the routines included in the matrix calculation external library 15a are used as routines of the particular operation. For example, in the case of matrix multiplication, a routine implemented by the matrix calculation framework module 15 or a General Matrix-Matrix Multiplication (GEMM) routine of a BLAS library may be selected by the matrix calculation framework module 15.

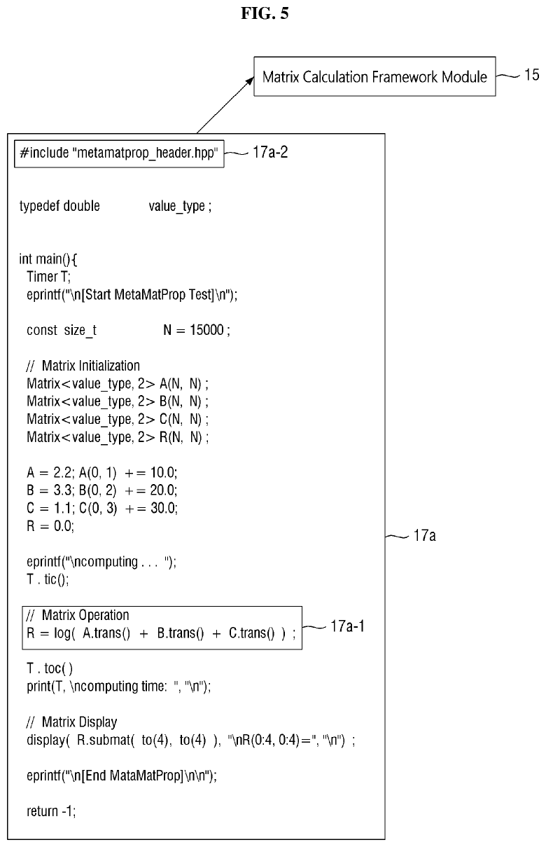

As illustrated in FIG. 5, a program code 17a of the application program including a matrix expression 17a-1 is written in a usual way, except for the addition of a statement 17a-2 for including the matrix calculation framework module 15. That is, the matrix calculation method according to some embodiments of the present invention can be executed by program code consisting of a statement (including a matrix expression) written in an existing manner. To this end, the matrix calculation framework module 15 may perform a matrix operation by overloading a matrix operation method of the general-purpose library 16 or an operator such as “+”, “−”, “*”, or “log”.

As already mentioned above, when the matrix calculation framework module 15 is included in the application program 17, static linking, dynamic linking, or template metaprogramming may be applied. That is, the matrix calculation method according to some embodiments of the present invention provides the convenience of using an existing program code written by a program developer, simply by adding a statement for including the matrix calculation framework module 15 to the existing program code. For example, the program code of the application program 17 may include a statement for including a header file of the matrix calculation framework module 15.

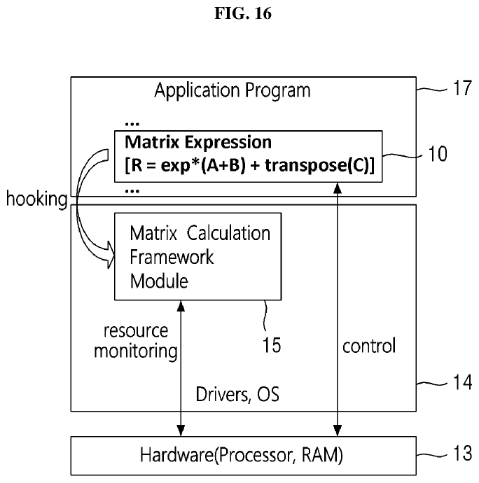

Alternatively, as will be described later, the matrix calculation framework module 15 may be implemented in an operating system/driver layer, as illustrated in FIG. 16. In this case, a matrix operation may be replaced with that of a matrix calculation framework by hooking a matrix operation call from the application program. Accordingly, even if a statement for including the matrix calculation framework module 15 is not added to program code, the calculation of a matrix expression by the matrix calculation framework module 15 can be optimized.

Also, in some embodiments, the matrix calculation framework module 15 may be implemented as a module inside an interpreter for executing the program code of the application program 17.

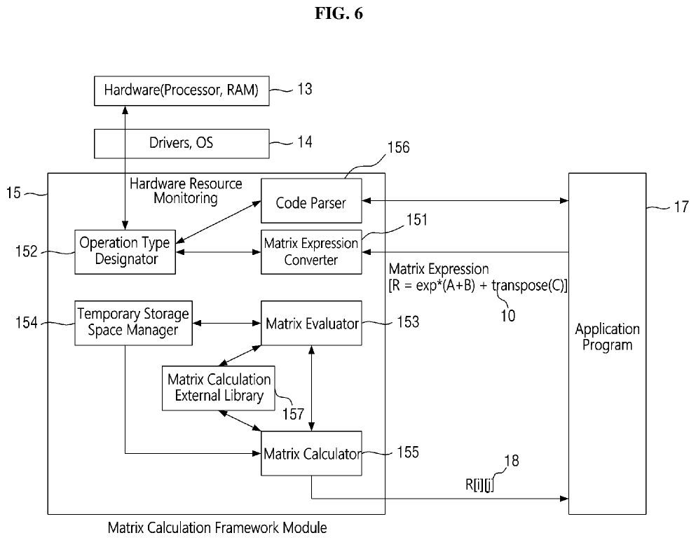

The configuration and operation of a matrix calculation device according to an embodiment of the present invention will hereinafter be described with reference to FIG. 6. FIG. 6 is a block diagram of a matrix calculation device according to an embodiment of the present invention. Referring to FIG. 6, blocks 151 through 157, which are included in the matrix calculation framework module 15, may be logical blocks that execute respective functional units and may be implemented in a software logic. Alternatively, the blocks 151 through 157 may be hardware units that execute the respective functional units and may be implemented by hardware equipped with calculation means such as a Field Programming Gate Array (FPGA) or a System-on-Chip (SoC). The configuration and operation of the matrix calculation device according to an embodiment of the present invention will hereinafter be described, focusing mainly on the configuration and operation of the matrix calculation framework module 15.

The matrix calculation framework module 15 receives data regarding a matrix expression included in the program code of the application program 17. For example, the data regarding the matrix expression may be provided to the matrix calculation framework module 15 when an element value of a result matrix from the matrix expression is accessed, the result matrix is assigned as an output matrix, the value of a variable defined as the matrix expression is accessed, or an evaluation function for the matrix expression is called. The evaluation function, which is a function outputting the value of an evaluation target expression designated as a parameter, may be, for example, an “eval( )” function supported by script languages such as Perl, JavaScript, and Python. As an element value access operator or function, an assignment operator, and the evaluation function are overloaded by the matrix calculation framework module 15, the data regarding the matrix expression may be provided to the matrix calculation framework module 15.

In some embodiments, the matrix calculation framework module 15 may perform calculation on the matrix expression at compile time. That is, a binary generated as a result of compiling the program code may include instructions related to the calculation of the matrix expression, configured by the matrix calculation framework module 15.

Also, in some embodiments, the matrix calculation framework module 15 may perform calculation on the matrix expression at run time. For example, when a program code written in an interpreter-type programming language is executed, the matrix calculation framework module 15 may perform calculation on the matrix expression. Also, for example, when the binary of a program code including the matrix expression is executed, the matrix calculation framework module 15 may perform calculation on the matrix expression by hooking the access of an element value of the result matrix from the matrix expression, the assignment of the result matrix as an output matrix, the access of the value of a variable defined as the matrix expression, or the call of the evaluation function for the matrix expression.

The interpreter-type programming language may be written in a script language interpreted and executed by a particular interpreter, such as Python or Matlab. Also, the program code may be a template source code interpreted by a language supporting template meta-programming, such as C++ 11.

It will hereinafter be described how the matrix calculation framework module 15 calculates each element value of a result matrix of a matrix expression.

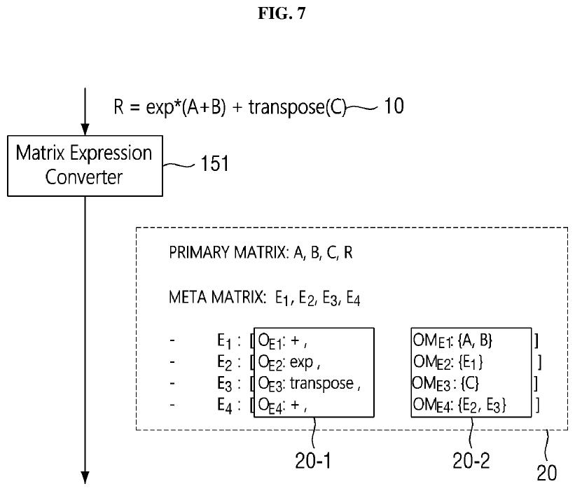

Referring to FIG. 7, a matrix expression converter 151 converts a matrix expression (hereinafter, the original matrix expression) provided by the application program 17. A transformation matrix expression 20 includes one or more operations 20-1 and operand matrices 20-2 of the operations 20-1. The operand matrices 20-2 may be primary matrices or meta matrices.

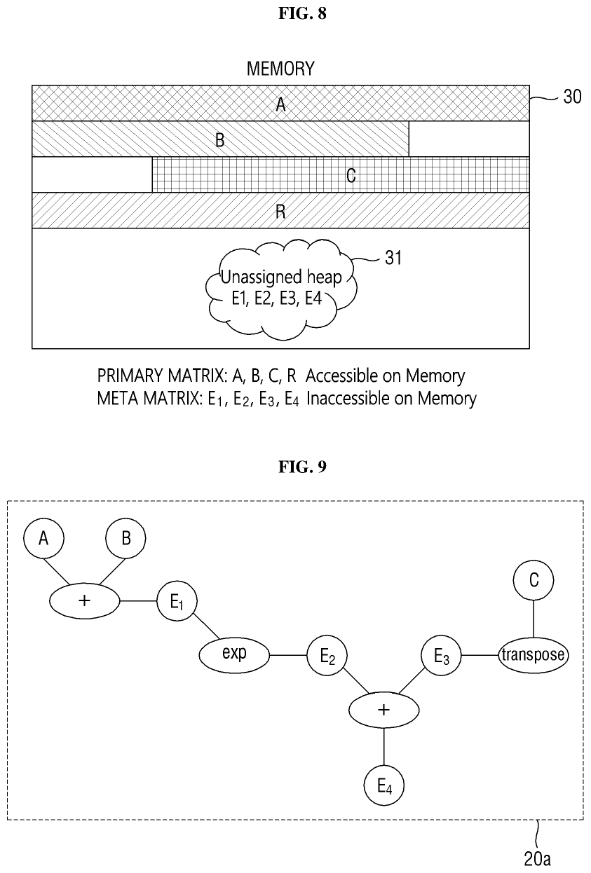

The primary matrices are matrices in which memory addresses of hardware 13 are designated, and element values of each of the primary matrices can be accessed through the memory addresses. A matrix in which element values are stored on a memory and a matrix to which a result matrix of a matrix expression is assigned are both primary matrices. The meta matrices refer to data in the form of logical matrices, generated by matrix operations and operand matrices of the matrix operations. As illustrated in FIG. 8, particular address zones on a memory 30 may be assigned to the primary matrices so that the primary matrices may be accessible on the memory 30 via the addresses. On the contrary, some of the data of the meta matrices may be temporarily stored in a heap zone 31 or another storage zone other than the heat zone 31, but the meta matrices, unlike the primary matrices, may be inaccessible on the memory 30.

As element values of each of the meta matrices are not calculated, the meta matrices are even more inaccessible on the memory 30. However, if operations of the meta matrices are of a particular type, element values of a result matrix of each of the meta matrices may be calculated and may be stored in temporary storage space. This will be described later.

FIG. 9 shows an original matrix expression 20a converted into primary matrices A, B, and C and meta matrices E₁, E₂, E₃, and E₄.

In some embodiments, the matrix expression converter 151 may classify operations included in the original matrix expression into a first type or a second type. That is, a converted matrix expression 21 obtained by the matrix expression converter 151 consists of operations 21-1, which are classified into first- or second-type operations, and operand matrices 21-2 of the operations 21-1.

In some embodiments, the first-type operations are matrix operations that can be calculated in a state where element values referenced by their operand matrix are accessible, and the second-type operations are matrix operations that can be calculated in a state where all element values of their operand matrix are accessible. In other embodiments, the first-type operations are matrix operations that can be calculated even when only the element values referenced by their operand matrix are accessible, and the second-type operations are matrix operations that can be calculated only when all the element values of their operand matrix are accessible.

The first-type operations will hereinafter be referred to as EOPs, and the second-type operations will hereinafter be referred to as non-EOPs (NOPs).

An EOP operation that can be subjected to element-wise computation. That is, an EOP may be understood as being an operation that only requires element values at respective locations of an operand matrix. For example, an element-wise arithmetic matrix operation such as (A+B) or (A-B), an element-wise mathematical matrix operation such as exp(A) or log(A), an element-wise logic matrix operation such as (A>B) or (A<B), or an element-wise transforming matrix operation such as matrix transpose may be an EOP.

On the contrary, an NOP is a matrix operation that cannot be calculated element-wise, but can be calculated in a state where all element values of its operand matrix are accessible. For example, an operation such as a GEMM routine of a BLAS library, Matrix Inverse, or Matrix Decomposition may be an NOP.

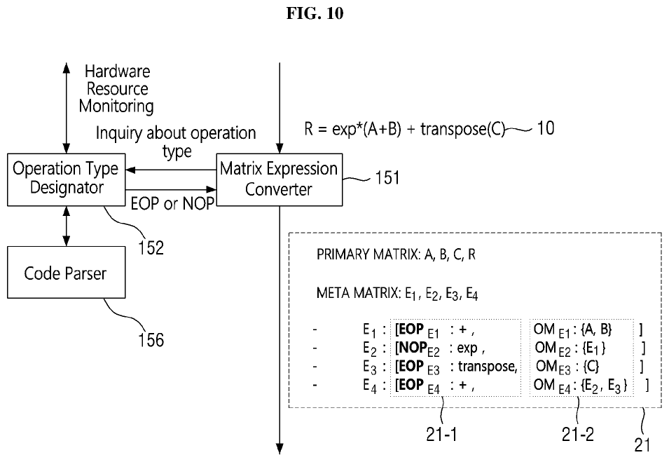

Referring to the converted matrix expression 21 of FIG. 10, “+” of E₁, “transpose” of E₃, and “+” of E₄ are EOPs, and “exp” of E₂ are NOPs.

The matrix expression converter 151 may make an inquiry to an operation type designator 152 about the types of operations included in the original matrix expression. Exemplary embodiments where the operation type designator 152 determines the type of each operation will hereinafter be described.

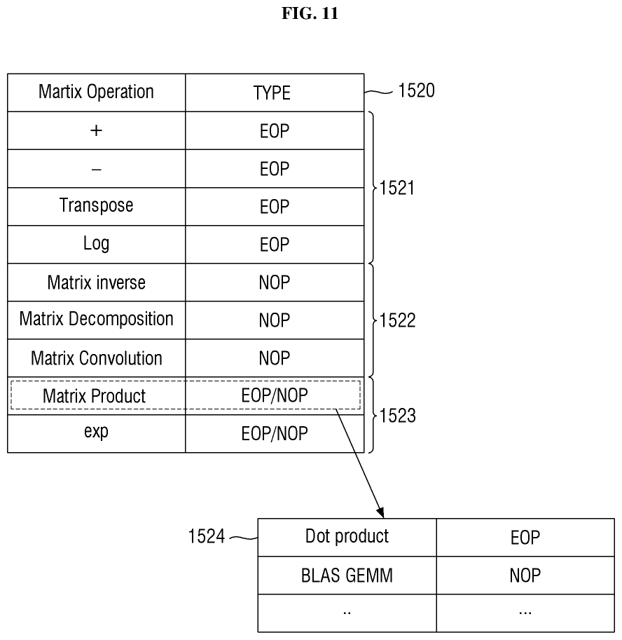

In some embodiments, the operation type designator 152 may determine whether each operation is an EOP or an NOP by referencing operation-wise type matching data. FIG. 11 shows exemplary operation-wise type matching data 1520. In a case where a particular operation is designated in the operation-wise type matching data 1520 as being of a single particular type, the operation type designator 152 may determine the type of the particular operation as the single particular type. For example, the operation type designator 152, which references the operation-wise type matching data 1520, may determine operations “+”, “−”, “transpose”, and “log” as EOPs 1521 and may determine the type of operations “matrix inverse”, “matrix decomposition”, and “matrix convolution” as NOPs 1522.

The operation-wise type matching data 1520 may designate some operations as being both EOPs and NOPs. For example, as shown in FIG. 11, operations “matrix product” and “exp” may be designated as being both EOPs and NOPs. Detailed type matching data 1524 shows that a “dot product” routine and a “BLAS GEMM” routine of “matrix product” may be an EOP and an NOP, respectively.

The operation type designator 152 may determine operations that can be both EOPs and NOPs as either EOPs or NOPs randomly or by prioritizing EOPs over NOPs or vice versa depending on status information

The status information may be, for example, hardware specification information or currently available hardware resource monitoring information. That is, the operation type designator 152 may determine each of the operations included in the original matrix expression as either an EOP or an NOP by reflecting the hardware specification information of a computing device. In a case where the present embodiment is performed at run time, rather than at compile time, an optimized matrix calculation can be performed for the computing environment of the device executing the application program 17, by using the hardware specification information or the currently available hardware resource monitoring information as the status information. The operation type designator 152 monitors the resource status of the hardware 13 by calling a method provided by the driver/OS 14, or may acquire the specification information of the hardware 13.

In some embodiments, the operation type designator 152 may perform a hardware profiling of the computing device by using at least one of hardware specification information and currently available hardware resource information of the computing device and may determine the operations that can be both EOPs and NOPs as either EOPs or NOPs based on the result of the hardware profiling.

In other embodiments, if the total or currently-available memory size of the computing device is less than a first size, the operation type designator 152 may determine the operations included in the original matrix expression as EOPs, and if the total or currently-available memory size of the computing device is greater than, or the same as, the first size, the operation type designator 152 may determine the operations as NOPs. This is because, as will be described later, the results of NOPs are stored in temporary storage space. That is, NOPs prevent duplicate calculations, but require memory space.

Also, in other embodiments, if the total or currently-available processing power installed in the computing device is less than a reference level, the operation type designator 152 may determine the operations included in the original matrix expression as EOPs, and if the total or currently-available processing power installed in the computing device is greater than, or the same as, reference level, the operation type designator 152 may determine the operations included in the original matrix expression as NOPs. For example, the reference level may be designated as the number of calculations per second. In a low-specification system such as an SoC or an embedded system, the total or currently-available processing power installed in the computing device may be less than the reference level, and there may be a restriction on memory usage. Thus, the operation type designator 152 may determine the operations included in the original matrix expression as EOPs.

The status information may be, for example, matrix expression quantity information of program code provided by a code parser 156. The code parser 156 may count the number of matrix expressions in program code by parsing the program code and identifying the matrix expressions. For example, the counted number of matrix expressions may be provided to the operation type designator 152 as the matrix expression quantity information. As the more matrix expressions in program code, the greater the memory usage, the operation type designator 152 may determine the operations that can be both EOPs and NOPs as EOPs to prevent memory shortage. On the contrary, as the less matrix expressions in program code, the lower the probability of memory shortage, the operation type designator 152 may determine the operations that can be both EOPs and NOPs as NOPs for a faster calculation speed.

The status information may be, for example, calculation mode information set via program code. For example, when the developer of the application program sets an operation mode to one of “speed priority” and “memory conservation priority” by using an operation mode setting method provided by the matrix calculation framework module 15, the operation type designator 152 may determine the type of each operation accordingly. For example, if the calculation mode information corresponds to a value indicating “speed priority”, the operation type designator 152 may determine the operations that can be both EOPs and NOPs as NOPs. On the contrary, if the calculation mode information corresponds to a value indicating “memory conservation priority”, the operation type designator 152 may determine the operations that can be both EOPs and NOPs as NOPs.

The status information may refer to, for example, sparse accessibility of element values of a result matrix of a matrix expression provided by the code parser 156. For example, if only element values that are less than a sparse access reference value, among the element values of a result matrix of a matrix expression X, are accessed, the type of operations of the matrix expression X may be determined to minimize NOPs. For example, when only one of the element values of the result matrix of the matrix expression X is accessed, the operations constituting the matrix expression X may be determined as EOPs all the time, except for unavoidable cases such as when only NOPs are provided.

In some embodiments, the greater the total or currently-available memory size of the computing device, the higher the sparse access reference value is set.

Embodiments where the operation type designator 152 determines each operation as an EOP or an NOP by referencing operation-wise type matching data have been described. In other embodiments, the operation type designator 152 may determine the type of each operation without a requirement of the operation-wise type matching data, and this will hereinafter be described.

The operation type designator 152 may determine operations basically as EOPs and may determine operations as NOPs only when an exception rule is satisfied. Here, the exception rule may be whether each target operation is included in a list of operations that can be processed only as NOPs. In this case, by minimizing operations that are calculated as NOPs, memory usage can be suppressed as much as possible, and as a result, large matrix calculations can be properly processed without any memory problems.

Alternatively, the operation type designator 152 may generally determine operations as NOPs and may determine operations as EOPs only when an exception rule is satisfied. Here, the exception rule may be whether each target operation is included in a list of 1:1 operations, which are operations accessing one element of their operand matrix to acquire an element of a result matrix. The 1:1 operations may include, for example, “+” and “−”. The “matrix product” operation may not be included in the list of 1:1 operations. In this case, all matrix operations except for the 1:1 operations are executed immediately, the results of the matrix operations are stored in temporary storage space, and only 1:1 operations having a less calculational load than NOP calculations are finally executed collectively, thereby increasing calculational speed. Obviously, the present embodiment may be effective in a computing environment with a sufficient memory size.

The conversion of an original matrix expression into a converted matrix expression by the matrix expression converter 151 has been described, focusing on how to determine each operation of the original matrix expression as one of an EOP or an NOP. Each operation included in the converted matrix expression is designated as an EOP or an NOP. Then, during the calculation of the matrix expression, NOPs are calculated in advance and are stored in temporary storage space, and EOPs are calculated lastly in an element-wise batch manner.

That is, EOPs may be understood as being computed in a delayed manner because the EOPs are calculated all together lastly. Also, as the results of EOPs are not stored in temporary storage space, memory space can be conserved. Also, processors can be efficiently used in the process of computing EOPs all together lastly. The advantages of memory conservation and speed improvement are apparent as compared to a conventional matrix calculation method in which all matrix operations are calculated immediately using two operand matrices and the results of the matrix operations are stored in temporary storage space.

In some embodiments, EOPs, but also NOPs may be computed in a delayed manner. Here, EOPs and NOPs may both be understood as being computed in a delayed manner because both EOPs and NOPs are calculated when element values of a final result matrix of an original matrix expression are accessed. In this case, when the element values of the final result matrix are accessed, the results of NOPs may be calculated first and may be stored in temporary storage space, and then, EOPs may be calculated in an element-wise batch manner.

It will hereinafter be described how to calculate each element value of a final result matrix of an original matrix expression with the use of a converted matrix expression.

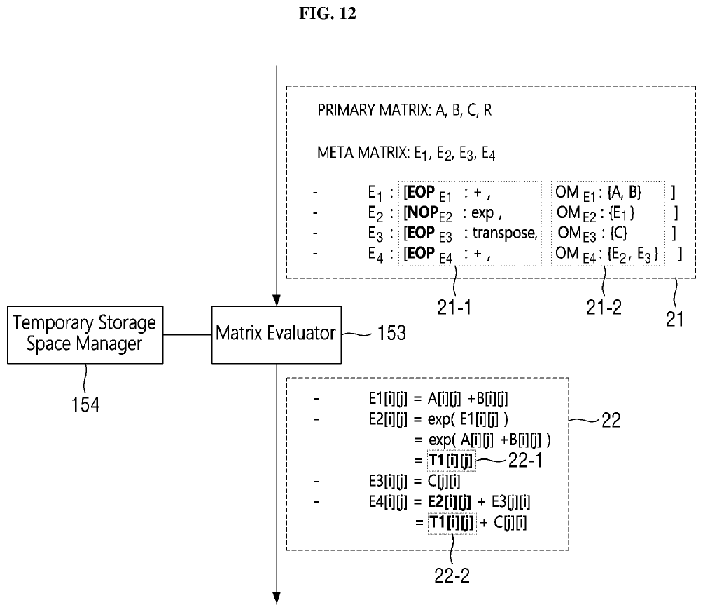

FIG. 12 illustrates how a matrix expression evaluator 153 creates a calculation formula for each element value of a final result matrix by evaluating the converted matrix expression 21. Referring to FIG. 12, for an EOP, a calculation formula for each element value of a meta matrix which is the result of the EOP is calculated, and for an NOP, each element value of a meta matrix which is the result of the NOP is calculated and is stored in temporary storage space. As the operation of the meta matrix E₂ is an NOP, each element value of the meta matrix E₂ is calculated and is stored in temporary storage space T1 (22-1).

As already mentioned above, the calculation of an NOP may be performed by calling a routine from the external library 157 such as BLAS.

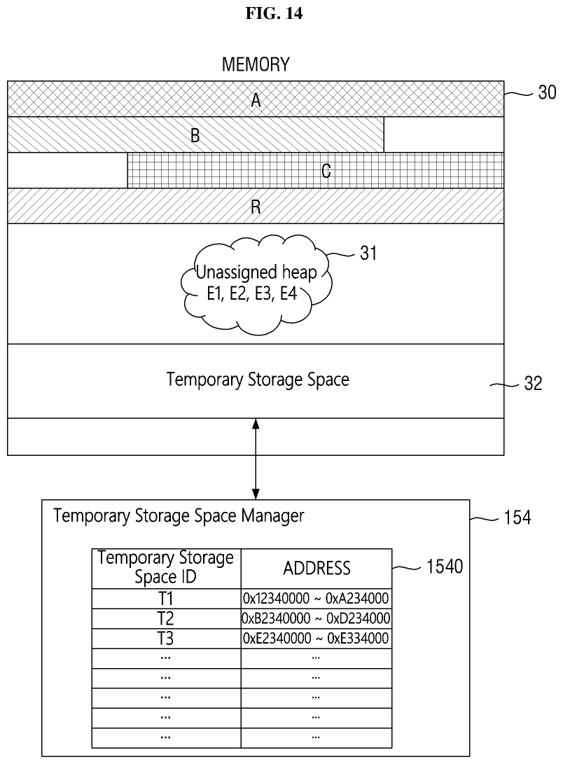

Temporary storage space may be allocated by a temporary storage space manager 154, and temporary storage space that is already used may be retrieved. Referring to FIG. 14, the temporary storage space manager 154 may allocate temporary storage space 32 in the heap zone that can be used by the application program and may determine the size of necessary temporary storage space based on the data size of each operand matrix. The temporary storage space manager 154 may manage the temporary storage space 32 by using a temporary storage space table 1540, which matches the identifiers and the addresses of temporary storage spaces.

A final meta matrix E4[i][j] is the sum of meta matrices E2[i][j] and E3[i][j], and the meta matrix E2[i][j] is a result matrix of an NOP and is readily accessible from the temporary storage space T₁ (22-2). The meta matrix E₃ is replaced with a calculation formula C[j][i] where C is a primary matrix and is thus accessible on the memory. That is, in the example of FIG. 12, the matrix expression evaluator 153 may produce the calculation formula for each element value of the final result matrix of the original matrix expression as “R[i][j]=T1[i][j]+C[j][i]”.

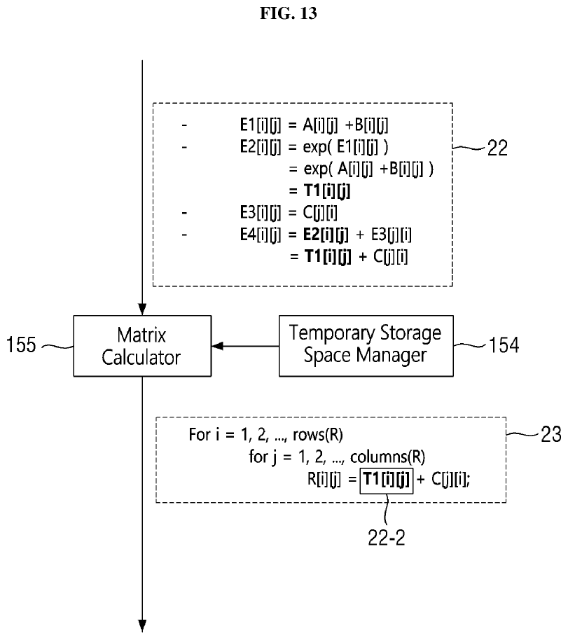

Thereafter, referring to FIG. 13, a matrix calculator 155 calculates each element value of the final result matrix. In some embodiments, the matrix calculator 155 may calculate each element value of the final result matrix through element-wise calculation. Here, each element value of a meta matrix of an EOP can be calculated even when not all element values of an operand matrix are accessible, but each element value of a meta matrix of an NOP can be calculated only when all element values of an operand matrix are accessible. For this reason, a result matrix of the meta matrix of the NOP may be understood as being calculated in advance and being stored in temporary storage space 23-1. That is, the matrix calculator 155 can calculate, element-wise, the element values of the final result matrix of the original matrix expression all together with the use of a calculation formula, i.e., R[i][j]=T₁[i][j]+C[j][i] (23).

As already mentioned above, in some embodiments, not only EOPs, but also NOPs may be calculated in a delayed manner. Here, NOPs and EOPs may be understood as being calculated in a delayed manner because they are both calculated when the element values of the final result matrix of the original matrix expression are accessed. When the element values of the final result matrix of the original matrix expression are accessed, the results of NOPs may be calculated first and may be stored in temporary storage space, and then, EOPs may be calculated element-wise all together.

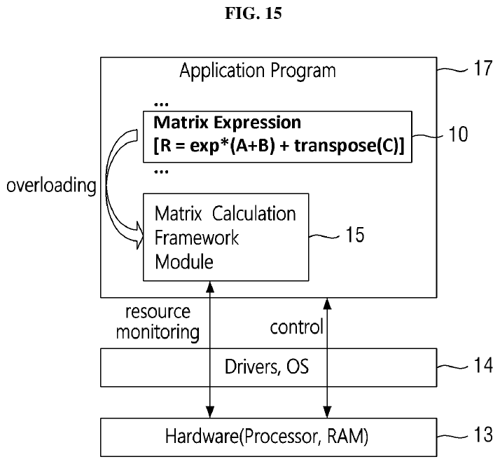

The configuration and operation of the matrix calculation device according to an embodiment of the present invention have been described, focusing on the operation of the matrix calculation framework module 15. Exemplary positions of the matrix calculation framework module 15 in a software hierarchical structure for executing the application program 17 will hereinafter be described with reference to FIGS. 15 and 16.

In some embodiments, the matrix calculation framework module 15 may be a module included in the application program 17, which includes the matrix expression 10. In this case, the matrix calculation framework module 15 may be executed inside the process of the application program 17. The matrix calculation framework module 15 may be complied together with the program code of the application program in a static link manner, may be linked to the binary of the application program in the form of a compiled library in a dynamic link method, or may be a routine required at compile time in a template metaprogramming method, compiled together with the program code of the application program.

Here, the matrix calculation framework module 15 may be executed by overloading operators or functions used for the program code of the application program to calculate a matrix expression. In this manner, the matrix calculation framework module can optimize the calculation of a matrix expression by using the result of monitoring hardware resource information.

In some embodiments, the matrix calculation framework module 15 may be executed in the driver/OS 14. In this case, the matrix calculation framework module 15 may be understood as being executed at run time.

Here, the matrix calculation framework module 15 may be executed as a service registered with the OS. The matrix calculation framework module 15 may hook a call of a matrix operation from the application program 17, the access of element values of a result matrix of the matrix expression, the access of the value of a variable defined as the matrix expression, or a call of an evaluation function for evaluating the result of the matrix expression, thereby replacing the matrix operation with that of a matrix calculation framework. In this case, the calculation of the matrix expression can be optimized by the matrix calculation framework module 15 without the need for the program code to link the matrix calculation framework module 15. That is, the calculation of a matrix expression can be optimized even for an application program that is already developed and distributed.

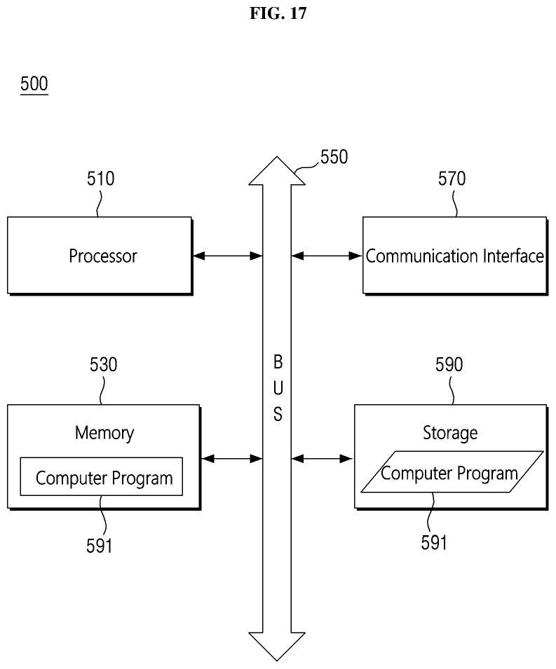

An exemplary computing device 500 capable of implementing the methods described in connection with various embodiments of the present invention will hereinafter be described with reference to FIG. 17.

FIG. 17 is a hardware configuration diagram illustrating the hardware structure of an exemplary first computing device for implementing a method according to some embodiments of the present invention.

Referring to FIG. 17, the computing device 500 may include one or more processors 510, a bus 550, a communication interface 570, a memory 530, which loads one or more computer programs 591 executed by the processors 510, and a storage 590, which stores the computer programs 591. FIG. 17 illustrates only the components relevant to embodiments of the present invention. Thus, it is obvious to one skilled in the art to which the present invention pertains that other general-purpose components other than those illustrated in FIG. 17 may be further provided. The computing device 500 of FIG. 13 may refer to one of physical servers belonging to a server farm that provides Infrastructure-as-a-Service (IaaS) cloud services.

The processors 510 control the general operations of the components of the computing device 500. Each of the processors 510 may be configured to include a Central Processing Unit (CPU), a Micro Processor Unit (MPU), a Micro Controller Unit (MCU), a Graphic Processing Unit (GPU), a General Purpose Graphics Processing Unit (GPGPU), a Digital Signal Processor (DSP), a Tensor Processor (TP), and other well-known arbitrary-type processors. The processors 510 may perform an operation on one or more applications or programs for executing methods/operations according to various embodiments of the present invention. The computing device 500 may include one or more processors.

The memory 530 stores various data, commands, and/or information. The memory 530 may load one or more programs 591 from the storage 590 to execute methods/operations according to various embodiments of the present invention. For example, when a computer programs 591 are loaded into the memory 530, the matrix calculation framework module 15 of FIG. 6 may be implemented on the memory 530. An example of the memory 530 may be a RAM, but the present invention is not limited thereto.

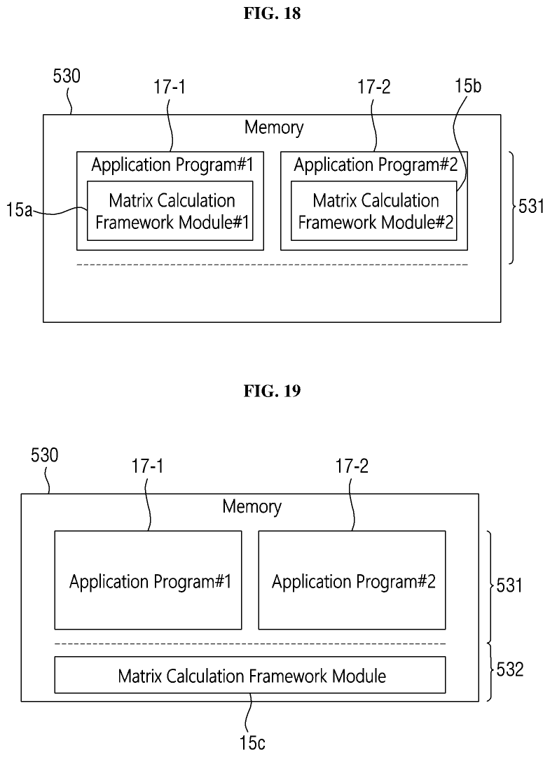

In some embodiments, as illustrated in FIG. 18, the matrix calculation framework module 15 may be loaded onto a user level 531 of the memory 530 as matrix calculation framework modules 15a and 15b embedded in application programs 17-1 and 17-2, respectively. Also, in other embodiments, as illustrated in FIG. 19, the matrix calculation framework module 15 may be loaded onto a kernel level 532 of the memory 530 in the form of a system service 15c, separately from the application programs 17-1 and 17-2.

The bus 530 provides a communication function between the components of the computing device 500. The bus 550 may be implemented as an address bus, a data bus, a control bus, or the like.

The communication interface 570 supports wired/wireless Internet communication of the computing device 500. The communication interface 570 may support various communication methods other than the Internet communication method. To this end, the communication interface 570 may be configured to include a well-known communication module.

The storage 590 may non-temporarily store one or more computer programs 591. The storage 590 may include a non-volatile memory such as a flash memory, a hard disk, a removable disk, or any type of well-known computer-readable recording medium.

The computer programs 591 may include one or more instructions that implement methods/operations according to various embodiments of the present invention. When the computer programs 591 are loaded into the memory 530, the processors 510 may execute the instructions and may thus perform methods/operations according to various embodiments of the present invention.

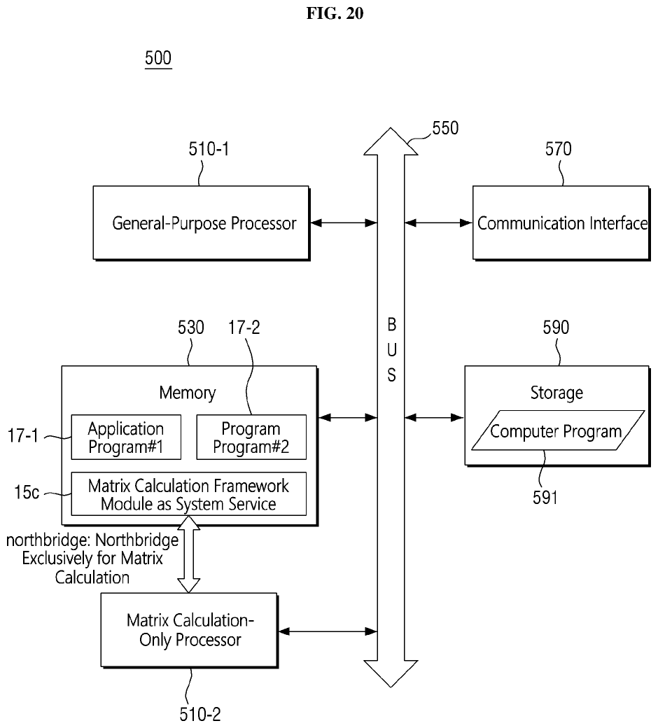

The computing device 500, which is capable of realizing methods/operations according to various embodiments of the present invention, may have a hardware structure specialized for matrix calculation. That is, as illustrated in FIG. 20, a matrix calculation-only processor 510-2, which is loaded all the time on the kernel level of the memory 530 and is connected to a matrix calculation framework module 15c as a system service via a matrix calculation-only northbridge, may be provided. The matrix calculation-only processor 510-2 may be understood as being a processor specialized for processing calculations requested by the matrix calculation framework module 15c.

For example, the matrix calculation-only processor 510-2 may be a GPU, a GPGPU, or a TP.

In some embodiments, the matrix calculation framework module 15c may process a first group of NOPs that are designated in advance, with the matrix calculation-only processor 510-2 and other NOPs and EOPs with a general-purpose processor 510-1. The first group of NOPs may include a matrix multiplication operation or a convolution operation that are in frequent use during machine learning. The general-purpose processor 510-1 may be, for example, a CPU.

The configuration and operation of the matrix calculation device according to an embodiment of the present invention have been described with reference to FIGS. 2 to 20. Obviously, the technical concept of the aforementioned matrix calculation device is applicable, with or without modifications, to a matrix calculation method that will be described later. It is noted that the technical concept of the matrix calculation method is also applicable, with or without modifications, to the aforementioned matrix calculation device.

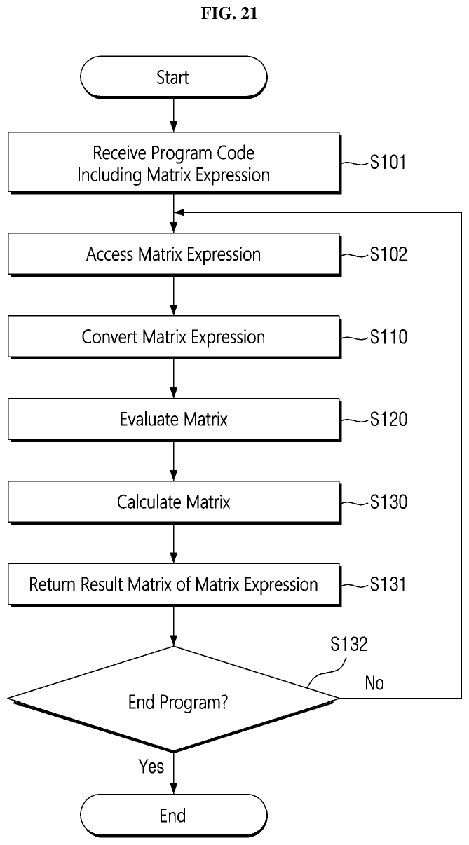

A matrix calculation method according to another embodiment of the present invention will be described with reference to FIGS. 21 to 24. For convenience of understanding, the foregoing will be briefly described. The method according to the present embodiment may be executed by a computing device. The computing device may be a computing device equipped with a program development environment or with an application program execution environment. It is noted that descriptions of a subject performing some operations included in the method according to the present embodiment may be omitted, in which case, the subject may be the computing device.

The matrix calculation method according to the present embodiment will hereinafter be described briefly with reference to FIG. 21. When a program code including a matrix expression is provided to a compilation environment or an execution environment for compilation or execution (S101) and element values of a result matrix of the matrix expression are accessed (S102), the matrix expression is converted into a transformation matrix expression (S110). Operations included in the transformation matrix expression are classified as either NOPs or EOPs.

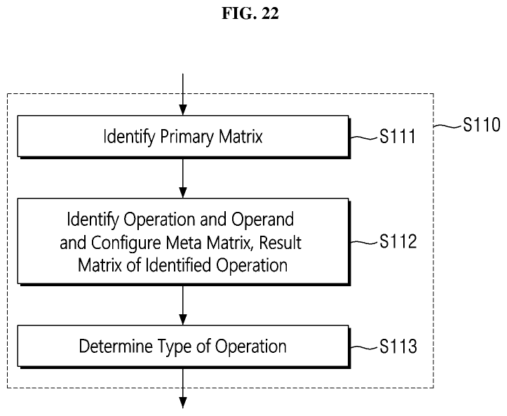

Referring to FIG. 22, the transformation matrix expression is generated by identifying primary matrices (S111), identifying operations and their operands to configure meta matrices of the identified operations (S112), and determining types of the operations (S113).

As already mentioned above, the operations may be classified into EOPs or NOPs in consideration of hardware specification information or hardware available resource information, in consideration of calculation mode information set by the developer of the application program, or in consideration of matrix expression quantity information using the result of parsing the program code.

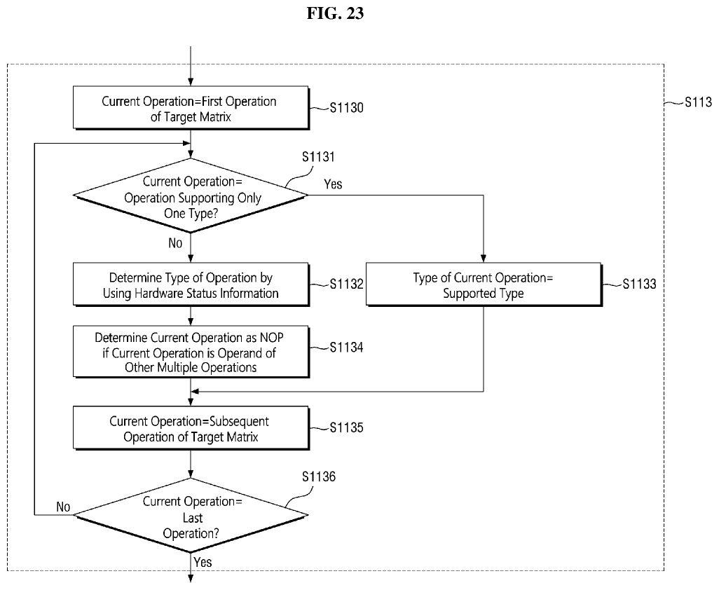

An example of S113 will hereinafter be described in further detail with reference to FIG. 23. The types of the operations of the transformation matrix expression are determined, starting with a first operation of the transformation matrix expression (S1130). If a current operation supports only one type (S1131), the current operation is determined as the corresponding type (S1133).

On the contrary, if the current operation does not support only one type (S1131), the type of the current operation may be determined in consideration of the hardware status information (S1132). Alternatively to what is shown in FIG. 23, the calculation mode information set by the developer of the application program or the matrix expression quantity information using the result of parsing the program code may be considered.

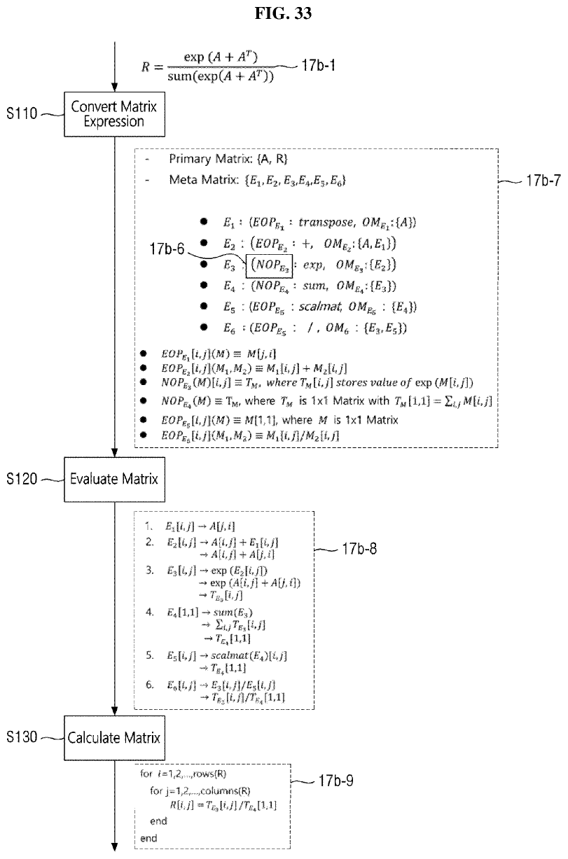

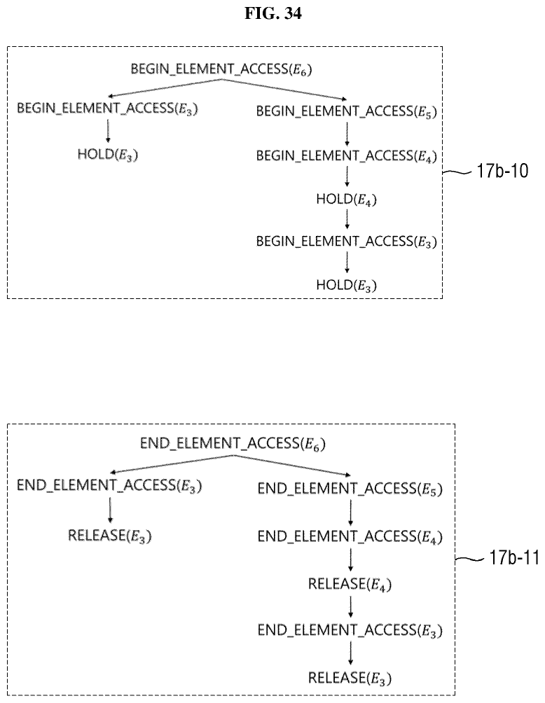

In some embodiments, matrix expression-wise calculation can be optimized by preventing the redundant calculation of operations that are included multiple times in the matrix expression. To this end, if the current operation is an operand of other multiple operations, the current operation is determined as an NOP (S1134), thereby preventing the redundant calculation of the operations that are included multiple times in the matrix expression. An expression of how to prevent the redundant calculation of the operations that are included multiple times in the matrix expression will be described later with reference to FIGS. 33 and 34.

S1131 through S1134 are repeated until the type of a last operation of the transformation matrix expression is determined (S1135 and S1136).

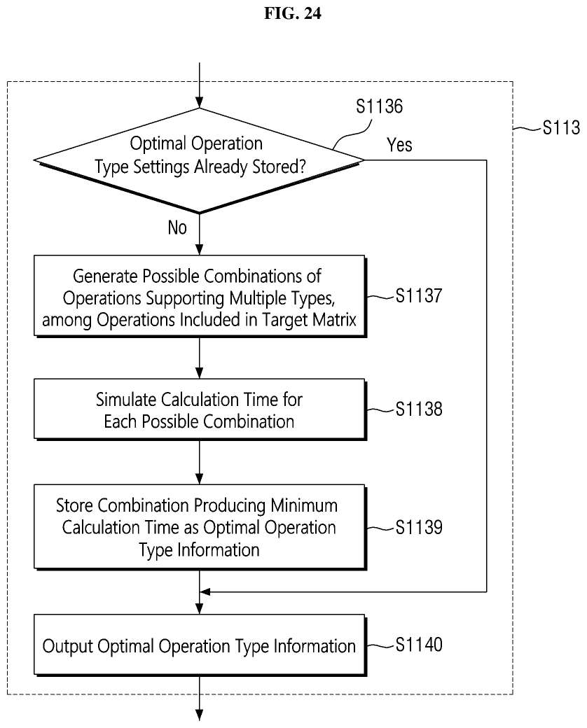

Another example of S113 will hereinafter be described with reference to FIG. 24. S113 of the present embodiment is performed when optimal operation type settings for a current matrix expression, which is a target matrix expression to be calculated, are not stored in advance (S1136). If optimal operation type settings for the current matrix expression are set in advance during a previous calculation process and are already stored, the stored optimal operation type settings may be directly applicable to the current matrix expression.

In S1137, possible combinations of operations supporting multiple types, among the operations of the transformation matrix expression, are generated. Here, as operations of the transformation matrix expression that support only one type are not variables, but constants, single-type operations may be included in the possible combinations.

In S1138, calculation time for each of the possible combinations is simulated. Then, in S1139, a combination that can produce a minimum calculation time may be stored as optimal operation type information.

That is, according to S113 of FIG. 24, various case scenarios that may occur due to the presence of operations that can be both EOPs and NOPs in one matrix expression can all be simulated, and an operation type setting that can produce a minimum calculation time can be found. According to the present embodiment, optimal operation type settings for each matrix expression are found, for example, at compile time, even if it takes a long time, and the found optimal operation type settings are applied, thereby achieving a fast calculation speed at run time later.

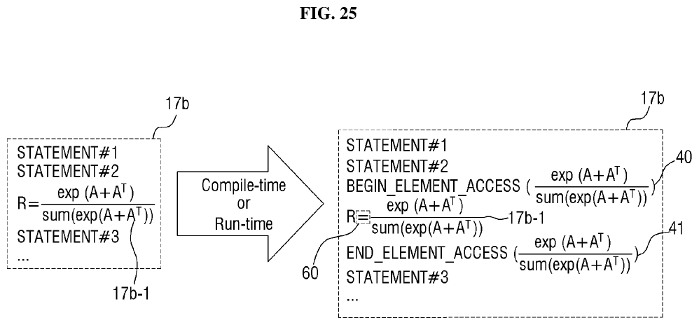

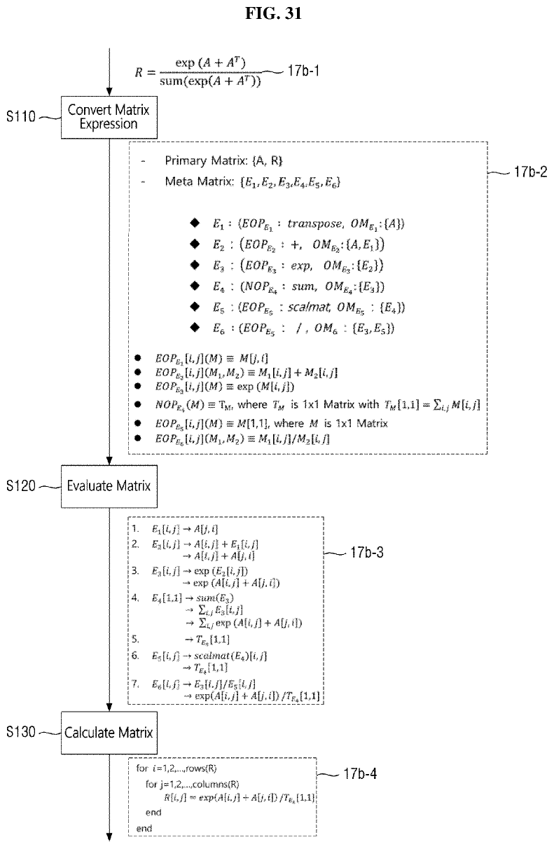

The basics of the matrix calculation method according to the present embodiment have been described with reference to FIGS. 21 through 24. Examples and derivative examples of the matrix calculation method according to the present embodiment will hereinafter be described with reference to FIGS. 25 through 35.

FIG. 25 shows that some routines are inserted in program code including a matrix expression, at compile time or run time. As shown in FIG. 25, in a case where the present embodiment is applied when program code 17b, which includes a matrix expression 17b-1, is compiled (“Compile-time”) or run (“Run-time”), an access begin routine 40 and an access end routine 41 may be automatically added at the front and rear of a statement including the matrix expression 17b-1. The access begin routine 40 and the access end routine 41 may be automatically added by, for example, the matrix calculation framework module 15.

Even though the matrix expression 17b-1 is included in the program code, the matrix expression 17b-1 does not need to be readily calculated. For example, the matrix expression 17b-1 needs to be calculated if the matrix expression 17b-1 is assigned to another result matrix, element values of the matrix expression 17b-1 are accessed, or if an evaluation function for evaluating the matrix expression is called. For example, referring to program code of FIG. 25, as there exists an operator “=” for allocating the matrix expression 17b-1 to another result matrix, the access begin routine 40 and the access end routine 41 may be automatically assigned according to the identification of the operator.

The access begin routine 40 is a routine that makes element values of a matrix, introduced as a parameter, accessible. The parameter may be a primary matrix, a meta matrix, or a matrix expression consisting of operations and operand matrices of the operations. Here, the operand matrices may be primary matrices or meta matrices.

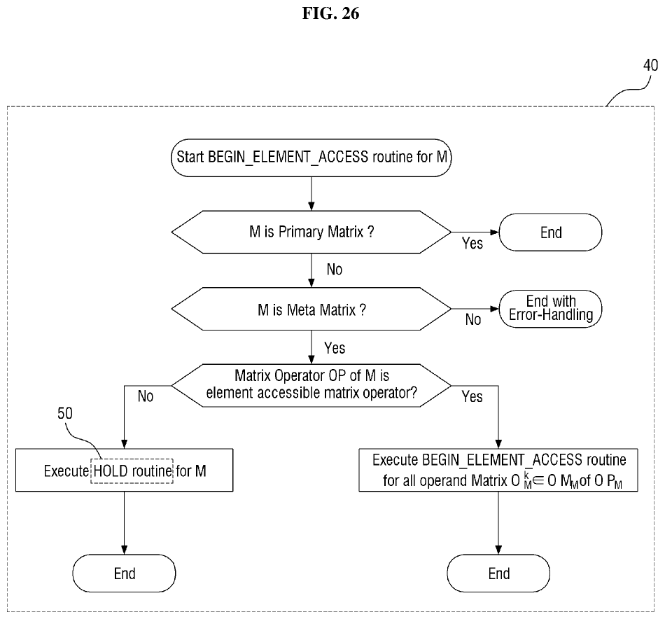

FIG. 26 illustrates the access begin routine 40. First, in a case where an input parameter M is a primary matrix, which is already accessible, the routine is terminated without performing any further operations. In a case where the input parameter M is neither a primary matrix nor a meta matrix, the routine is terminated with error handling because the corresponding data cannot be processed by the input parameter.

Unless the input parameter M is a primary matrix, there may exist a matrix operator of the input parameter M. If the matrix operator is element-accessible, i.e., if the matrix operator is an EOP, the access begin routine 40 may be executed for all operand matrices of the matrix operator, thereby making all the operand matrices accessible. That is, the access begin routine 40 may be understood as being a recursive routine.

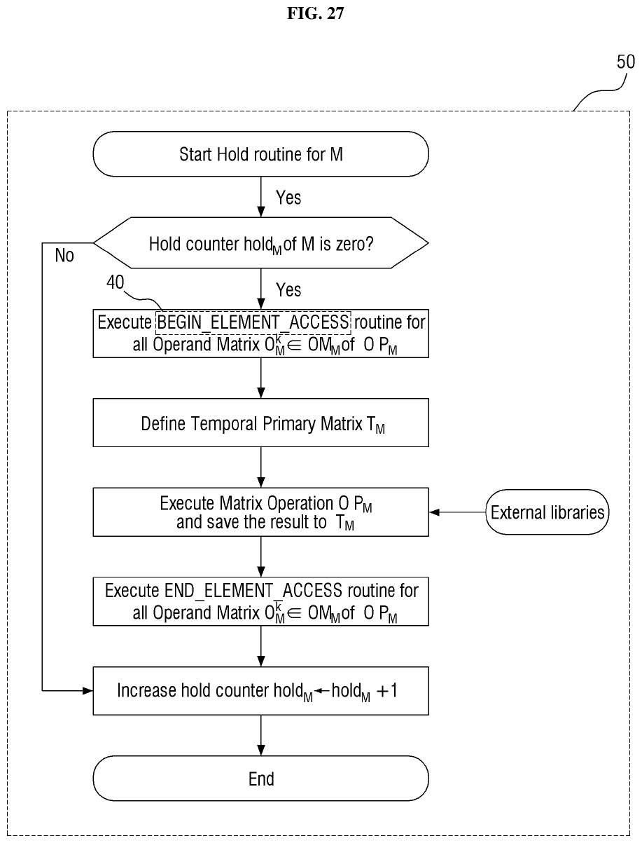

If the matrix operator is not element-accessible, i.e., if the matrix operator is an NOP, the NOP is calculated, and the result of the calculation is stored in temporary storage space, as already mentioned above. To this end, a HOLD routine 50 is executed for the input parameter M. The HOLD routine 50 will hereinafter be described in detail with reference to FIG. 27.

At the beginning of a HOLD(M) routine, the value of hold_{M}, which is a HOLD counter for M, is checked. The value of hold_{M} may be, for example, a value managed by the matrix calculation framework module 15, and the initial value of hold_{M} is “0”. The value of hold_{M} increases by “1” whenever the HOLD routine is called for M. That is, the value of hold_{M} may be understood as indicating the number of times that the access of M, which is a result matrix of an NOP, has been requested. Therefore, if the value of hold_{M}, the HOLD counter for M, is not “0” at the beginning of the HOLD(M) routine, the HOLD(M) routine simply increases the value of hold_{M} by “1” and is terminated.

If the value of hold_{M} is “0”, M is calculated, and the result of the calculation may be stored in temporary storage space. To this end, all the operand matrices of M need to be accessible, and thus, the access begin routine 40 is called for all the operand matrices of M before the calculation of M. Thereafter, temporary storage space for storing the result of the calculation of M is assigned, and each element value of the result matrix of M is calculated by calling a routine of an external library or a matrix calculation routine implemented in the matrix calculation framework module 15. Once the calculation is complete, the access end routine 41 is called for each of the operands of M, the value of hold_{M} is increased by “1”, and the routine ends.

The functions of the access begin routine 40 and the HOLD routine 50, which is called when an operator of a matrix initiated with the access begin routine 40 is an NOP, have been described. A batch computation of the matrix M may be prepared by calling the access begin routine 40 for the matrix M. Although not specifically mentioned with regard to the access begin routine 40, a pretreatment process of FIGS. 10 and 11 that converts a matrix expression into a transformation matrix expression may be performed before the calculation of the matrix expression.

A matrix expression may be made computable by calling the access begin routine 40, and may be computed when a result matrix of the matrix expression is assigned to another matrix, element values of the matrix expression are accessed, the value of a variable defined as the matrix expression is accessed, or an evaluation function for evaluating the matrix expression is called.

For example, an operator “=”, which assigns a result matrix of a matrix expression to another matrix, a method by which element values of the matrix expression are accessed, and an evaluation function for evaluating the matrix expression may be overloaded by the matrix expression framework module, and as a result, matrix calculation according to the present embodiment may be called without changing the existing program code. In the example of FIG. 25, an element value evaluation routine 60, overloaded with the operator “=”, may be performed. The overloaded element value evaluation routine 60 may be called only when there exists a matrix expression on the right side of the operator “=”.

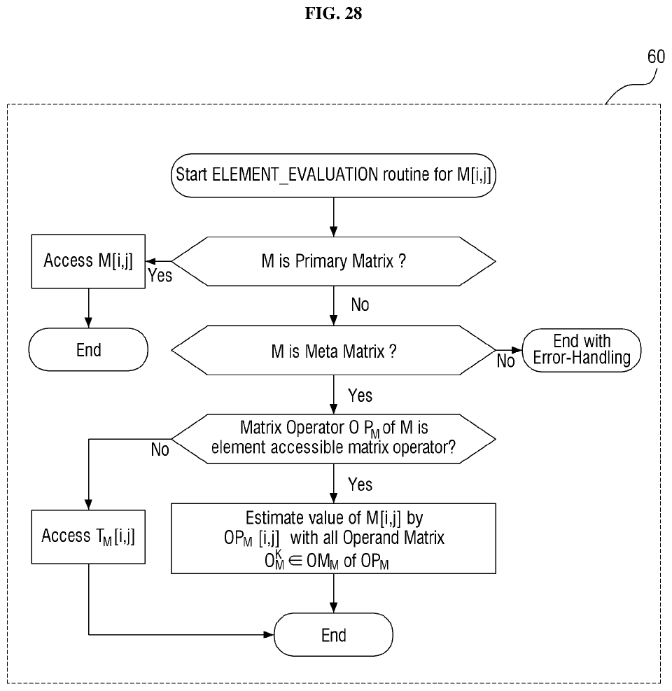

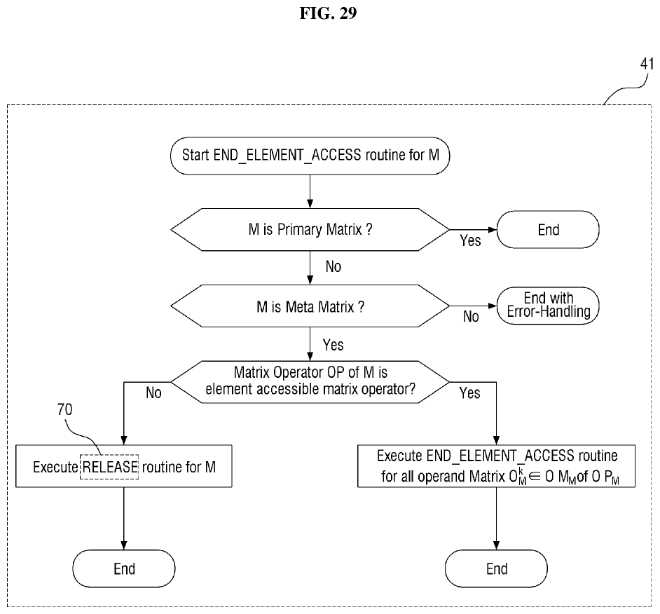

Referring to FIG. 28, if the matrix M is a primary matrix, an element value evaluation routine 60 for the matrix M readily accesses and outputs “M[i][j]”, and the routine ends. Also, if the matrix M is not a meta matrix, the element value evaluation routine 60 ends with error handling. Also, if an operation of the matrix M is an NOP, the element value evaluation routine 60 may access “M[i][j]” from temporary storage space TM where the result of computation of the NOP is stored, via a HOLD routine. Also, if the operation of the matrix M is an EOP, the element value evaluation routine 60 computes the operation of the matrix M. To this end, the element value evaluation routine 60 is called for each operand matrix of the operation of the matrix M. That is, the element value evaluation routine 60 may be understood as being a recursive routine.

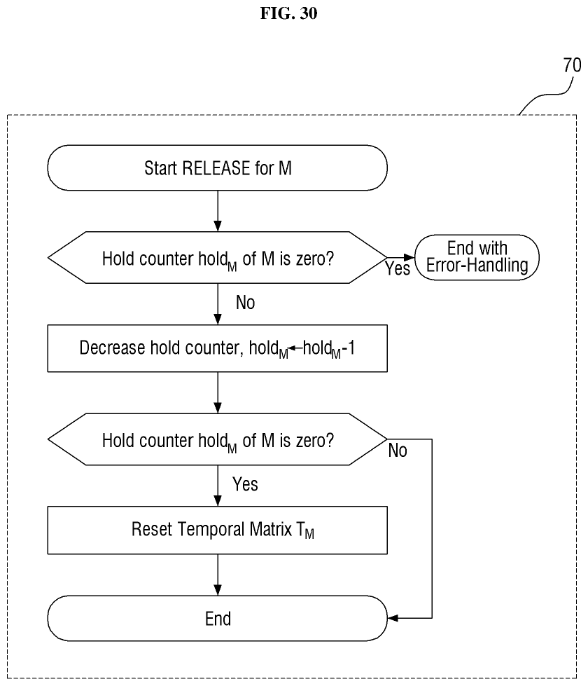

The access end routine 41 will hereinafter be described with reference to FIG. 29. The access end routine 41 for the matrix M readily ends if the matrix M is a primary matrix, ends with error handling if the matrix M is a meta matrix, is recursively called for all operand matrices of the matrix M if the operation of the matrix M is an EOP, and calls a RELEASE routine 70 for the matrix M if the operation of the matrix M is an NOP. The RELEASE routine 70 will hereinafter be described with reference to FIG. 30.

Referring to FIG. 30, the RELEASE routine 70 for the matrix M is a routine for lowering the hold counter by 1 when the access of the result of NOP computation is complete, and releasing the temporary storage space allocated by an access count HOLD routine 27 to make the corresponding memory available, when the hold counter reaches 0

It will hereinafter be described in what order the exemplary routines of FIGS. 26 through 30 are called for an exemplary matrix expression.

The matrix expression 17b-1 is converted into a transformation matrix expression 17b-2 by a matrix expression conversion step (S110). The transformation matrix expression 17b-2 consists of a total of six meta matrices, i.e., E₁ through E₆, among which E₄ is an NOP and the others are EOPs. Thereafter, in a matrix evaluation step (S120), a calculation formula 17b-3 for the transformation matrix expression 17b-2 is generated. Thereafter, in a matrix computation step, each element value of the matrix expression 17b-1 is computed element-wise by an element-wise computation of E₆, the final operation.

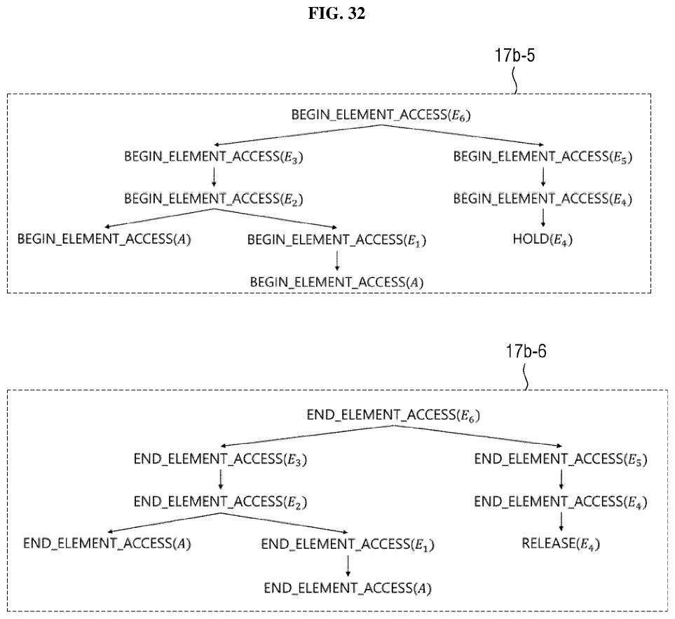

FIG. 32 shows call flows 17b-5 and 17b-6 of the access begin routine 40 and the access end routine 41, which are automatically assigned to the front and the rear of the statement including the matrix expression 17b-1. If an operation of each meta matrix is an EOP, the access begin routine 40 and the access end routine 41 are recursively called for all operand matrices, and if the operation of each meta matrix is an NOP, the HOLD routine 50 is called for the access begin routine 40, and the RELEASE routine 70 is called for the access end routine 41.

According to the transformation matrix expression 17b-2, the meta matrix E₃ is designated as an EOP even though the meta matrix E₃ is an operand matrix of each of E₄ and E₆. This means that the computation of a result value of E₃ is redundantly performed. To prevent this, an operator “exp” of a meta matrix that is used redundantly as an operand of another meta matrix may be designated as an NOP (17b-6). FIGS. 33 and 34 show call flows 17b-10 and 17b-11 of the access begin routine 40 and the access end routine 41 when the operator “exp” is adjusted from an EOP to an NOP (17b-6).

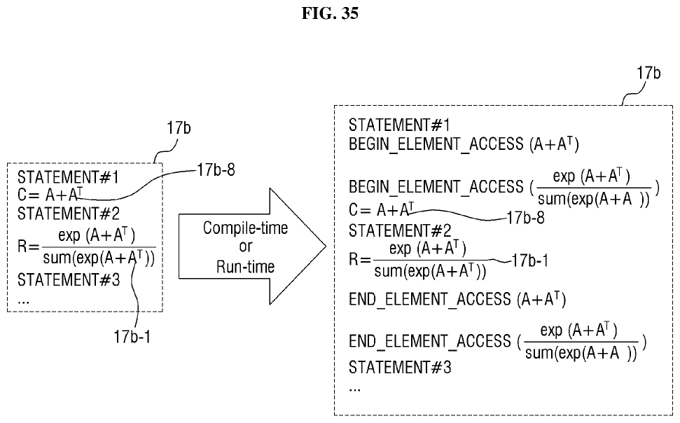

In some embodiments, a plurality of matrix expressions may be computed all together. For example, as shown in FIG. 35, if no statement changing element values of a primary matrix included in a first matrix expression 17b-8 or a second matrix expression 17b-1 exists between the first matrix expression 17b-8 and the second matrix expression 17b-1 (i.e., if STATEMENT#2 is not for changing element values of a primary matrix or if the first matrix expression 17b-8 and the second matrix expression 17b-1 are directly adjacent to each other, a statement for calling the access begin routine 40 may be automatically assigned at the front of the first matrix expression 17b-8, and a statement for calling the access end routine 40 may be automatically assigned to the rear of the second matrix expression 17b-1. In this manner, a plurality of matrix expressions can be computed all together.

In this case, if the same NOP exists in different matrix expressions, the result of the NOP is stored, and the different matrix expressions share and access the result of the NOP, thereby improving the efficiency of computation. For example, as a matrix expression “A+AT” (17b-8) is written three times, a matrix summation (+) operation of “A” and “AT” may be computed not as an EOP, but as an NOP.

For convenience, the present invention has been described, taking a 2-dimensional (2D) matrix as an example. However, it is noted that the aforementioned embodiments of the present invention are applicable regardless of the dimension of a matrix.

In some embodiments, if a statement assigning a result matrix of a matrix expression to a primary matrix is included in program code and all operations of the matrix expression are determined as NOPs, not temporary storage space may be allocated for storing the result of computation of the NOPs for processing the statement, but an assigned area, on a memory, of the primary matrix may be used as temporary storage space. For example, if a statement “R=A*B” is included in program code and a matrix multiplication (*) operation is an NOP (where R, A, and B are all primary matrices), the address of temporary storage space for storing the result of A*B may be designated as the memory address of R, instead of assigning temporary storage space T for storing the result of A*B, storing the result of A*B in the temporary storage space T, and performing an element-wise assigned operation (or an EOP) where the temporary storage space T is allocated to R. In this manner, the use of memory space can be conserved from the allocation of temporary storage space, and the amount of time that it takes to perform an element-wise assigned operation (or an EOP) as a memory storage space for R can be reduced. The present embodiment may be performed by calling an external library for performing an NOP. For example, if the matrix multiplication (*) of A*B is performed by calling a GEMM routine of a BLAS library, the statement “R=A*B” can be processed by calling “GEMM(R, A, B)”.

Test results showing the performance of matrix calculation according to some embodiments of the present invention will hereinafter be described. Table 1 below shows comparison targets for a test. A framework MMP refers to a framework to which embodiments of the present invention are applied.

TABLE 1

| | programming | execution | HW | internal |
|---|---|---|---|---|
| framework | interface | environment | platform | BLAS routine |
| MMP | C++ | stand-alone | CPU | Intel MKL |
| Armadillo | C++ | stand-alone | CPU | Intel MKL |
| Matlab | m-script | interpreter | CPU | Intel MKL |
| Tensorflow | python | interpreter | CPU | Eigen |

Table 2 below describes the testing environment.

TABLE 2

| | CPU-base platform |
|---|---|
| OS | CentOS 7.2.1511 (Linux) |
| CPU unit | dual Intel Xeon E5-2620 v4 @ 2.1 Ghz |
| | (16 CPU cores, 32 GB of Memory) |
| GPU unit | None |

Table 3 below shows test-target operations. The performance of the computation of EOPs was mainly tested.

TABLE 3

| benchmark ID | operations |
|---|---|
| EOP-00 | R = α + β * (A + B) + γ * A ∘ B |
| EOP-01 | R = α + β * (A^{T} + B) + γ * (A ∘ B^{T}) |
| EOP-02 | R = α + β * (A^{T} + B^{T}) + γ * (A^{T} ∘ B^{T}) |

Note that A, B, and R are all m × m 2-dimensional square matrices.

Table 4 below shows indexes for comparison of relative computation time. The framework MMP according to the present invention exhibits the lowest computation time.

TABLE 4

| preci- | bench- | MMP | Armadillo | Matlab | Tensorflow |
|---|---|---|---|---|---|
| sion | mark | (CPU-16) | (CPU-16) | (CPU-16) | (CPU-16) |
| single | EOP-00 | 1 | 2.31 | 7.81 | 11.85 |
| | EOP-01 | 1 | 5.98 | 8.71 | 6.47 |
| | EOP-02 | 1 | 8.07 | 20.85 | 10.84 |
| double | EOP-00 | 1 | 2.26 | 8.31 | 14.33 |
| | EOP-01 | 1 | 4.26 | 8.41 | 6.11 |
| | EOP-02 | 1 | 5.70 | 20.34 | 12.38 |

Table 5 below shows indexes for comparison of memory usage. The framework MMP according to the present invention exhibits the lowest memory usage.

TABLE 5

| bench- | preci- | MMP | Armadillo | Matlab | Tensorflow |
|---|---|---|---|---|---|
| mark | sion | (CPU-16) | (CPU-16) | (CPU-16) | (CPU-16) |
| single | EOP-01 | 1 | 1 | 2.06 | 2.87 |
| | EOP-01 | 1 | 1 | 2.06 | 2.87 |
| | EOP-02 | 1 | 1 | 2.40 | 3.22 |
| double | EOP-00 | 1 | 1 | 1.87 | 2.77 |
| | EOP-01 | 1 | 1 | 1.86 | 2.77 |
| | EOP-02 | 1 | 1 | 2.20 | 3.11 |

The technical idea of the present invention described with reference to FIGS. 2 to 35 may be implemented as computer-readable code on a computer-readable medium. The computer-readable recording medium may be, for example, a removable recording medium (e.g., a CD, a DVD, a Blu-ray disk, a USB storage device, or a removable hard disk) or a fixed recording medium (e.g., a ROM, a RAM, or a computer-equipped hard disk). The computer program recorded on the computer-readable recording medium may be transmitted to another computing device through a network such as the Internet and may be installed in, and used by the other computing device.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A matrix calculation method performed by a computing device, comprising:
converting an original matrix expression included in program code into a transformation matrix expression including meta matrices, which are combinations of operations of one of first and second types and operand matrices;
calculating a calculation formula of each element value of a final result matrix by evaluating the transformation matrix expression;
calculating a calculation result matrix of an operation of the second type, which is referenced as an operand matrix of the calculation formula; and
calculating element values of the final result matrix by calculating a result of calculation of an operation of the first type in accordance with the calculation formula, with the use of element values of the calculation result matrix of the operation of the second type.

2. The matrix calculation method of claim 1, wherein
the calculating the calculation formula of each element value of the final result matrix by evaluating the transformation matrix expression and the calculating the calculation result matrix of the operation of the second type, which is referenced as the operand matrix of the calculation formula, comprise calculating the calculation formula of each element value of the final result matrix by evaluating the transformation matrix expression at a first point of time, and calculating the calculation result matrix of the operation of the second type, which is referenced as the operand matrix of the calculation formula, at a second point of time, which is later than the first point of time, and
the calculating the element values of the final result matrix by calculating the result of calculation of the operation of the first type in accordance with the calculation formula, with the use of the element values of the calculation result matrix of the operation of the second type, comprises calculating a result of element-wise batch calculation of the operation of the first type in accordance with the calculation formula, with the use of the element values of the calculation result matrix of the operation of the second type.

3. The matrix calculation method of claim 1, wherein
the converting the original matrix expression into the transformation matrix expression, comprises classifying each operation included in the original matrix expression into the first type or the second type by referencing operation-wise type matching data.

4. The matrix calculation method of claim 1, wherein the converting the original matrix expression into the transformation matrix expression, comprises classifying each operation included in the original matrix expression, basically, into the first type and classifying each operation included in the original matrix expression into the second type, only if an exception rule is satisfied.

5. The matrix calculation method of claim 1, wherein the converting the original matrix expression into the transformation matrix expression, comprises classifying each operation included in the original matrix expression into one of the first and second types by reflecting hardware specification information of the computing device.

6. The matrix calculation method of claim 5, wherein the classifying each operation included in the original matrix expression into one of the first and second types by reflecting the hardware specification information of the computing device, comprises classifying a first operation included in the original matrix expression into the first type if a memory size of the computing device is less than a first size, and classifying the first operation into the second type if the memory size of the computing device is greater than, or the same as the first size.

7. The matrix calculation method of claim 5, wherein the converting the original matrix expression into the transformation matrix expression is performed at a time of execution of the program code.

8. The matrix calculation method of claim 1, wherein the converting the original matrix expression into the transformation matrix expression, comprises classifying each operation included in the original matrix expression into one of the first and second types in consideration of available hardware resources at a time of matrix expression conversion by the computing device.

9. The matrix calculation method of claim 1, wherein the converting the original matrix expression into the transformation matrix expression, comprises classifying a first operation into the second type if a result of calculation of the first operation is an operand of other multiple operations.

10. The matrix calculation method of claim 9, wherein
the multiple operations include operations of a neighboring matrix expression of the original matrix expression,
the neighboring matrix expression is a matrix expression not including a statement for changing element values of a primary matrix between the original matrix expression and the neighboring matrix expression, on the program code, and
the element values of the primary matrix are stored in a memory of the computing device.

11. The matrix calculation method of claim 1, wherein the converting the original matrix expression into the transformation matrix expression, comprises performing the evaluating the transformation matrix expression and the calculating the calculation result matrix, while changing a result of classification of the type of each operation included in the transformation matrix expression, and measuring execution time, and determining an optimal type of each operation included in the transformation matrix expression based on the execution time.

12. The matrix calculation method of claim 1, wherein the calculating the calculation result matrix of the operation of the second type, comprises identifying a calculation flag of the calculation result matrix of the operation of the second type, and calculating a result of calculation of the operation of the second type and storing data of the calculation result matrix of the operation of the second type in temporary storage space, if the calculation flag indicates that the calculation of the operation of the second type is yet to be performed.

13. The matrix calculation method of claim 1, wherein the converting the original matrix expression into the transformation matrix expression, the calculating the calculation formula of each element value of the final result matrix, the calculating the calculation result matrix of the operation of the second type, and the calculating the element values of the final result matrix are performed by a matrix calculation framework module included in a program of the program code, at a time when the element values of the final result matrix of the original matrix expression are accessed by an application program formed by the program code.

14. The matrix calculation method of claim 13, wherein the converting the original matrix expression into the transformation matrix expression, the calculating the calculation formula of each element value of the final result matrix, the calculating the calculation result matrix of the operation of the second type, and the calculating the element values of the final result matrix are performed when an operator that is overloaded by a matrix calculation framework module included in the program of the program code and assigns the original matrix expression to another matrix is executed or when an evaluation for the original matrix expression, overloaded by the matrix calculation framework module, is called.

15. The matrix calculation method of claim 1, wherein
the converting the original matrix expression into the transformation matrix expression, comprises converting the original matrix expression into the transformation matrix expression, which is a set of meta matrices that are combinations of operations of the first type or the second type and operand matrices of the operations,
each of the operand matrices is at least one of a primary matrix whose element values are stored in a memory of the computing device and a meta matrix whose element values are not stored in the memory of the computing device.

16. A matrix calculation method performed by a computing device, comprising:
including a matrix calculation framework module in a program of program code including an original matrix expression; and
performing, by the matrix calculation framework module, an optimized matrix calculation if element values of a result matrix of the original matrix expression are accessed,
wherein
the performing the optimized matrix calculation, comprises classifying an operation of the original matrix into one of an operation of a first type, which is a matrix operation that can be computed even when element values of an operand matrix are only accessible, and an operation of a second type, which is a matrix operation that can be calculated when all the element values of the operand matrix are accessible, calculating a result matrix of the operation of the second type and storing data of the result matrix of the operation of the second type in temporary storage space of the computing device, and calculating each element value of the result matrix of the original matrix expression by using a calculation formula for each element value of the result matrix of the original matrix expression,
the calculation formula includes the operation of the first type and an operand matrix of the operation of the first type, and
the operand matrix is at least one of a result matrix of the operation of the second type and a primary matrix whose element values are stored in a memory of the computing device.

17. The matrix calculation method of claim 16, wherein the performing the optimized matrix calculation, further comprises performing, by the matrix calculation framework module, the optimized matrix calculation when the element values of the result matrix of the original matrix expression included in the program code are accessed during compilation of the program code.

18. The matrix calculation method of claim 16, wherein the performing the optimized matrix calculation, further comprises performing, by the matrix calculation framework module, the optimized matrix calculation when the element values of the result matrix of the original matrix expression included in the program code are accessed during execution of the program code.

19. The matrix calculation method of claim 16, wherein the classifying the operation of the original matrix into one of the first and second types, comprises generating, by the matrix calculation framework module, a hardware profile by using at least one of hardware specification information and available hardware resource information of the computing device, and classifying, by the matrix calculation framework module, the operation of the original matrix into one of the first and second types by using the hardware profile.

20. A matrix calculation method performed by a computing device, comprising:
including a matrix calculation framework module in a program of program code including a matrix expression; and
performing, by the matrix calculation framework module, matrix calculation at a time of compilation or execution of the program code,
wherein
the performing the matrix calculation, comprises classifying an operation of the matrix expression into one of first and second types, and calculating each element value of a result matrix of the matrix expression with an operation of the first type, and
data of a result matrix of an operation of the second type, among operand matrices of the operation of the first type, is accessed from temporary storage space of the computing device.
